(19) United States
(12) Patent Application Publication
(10) Pub. No.: US 2015/0311571 A1
(43) Pub. Date: Oct. 29, 2015

(54) BATTERY CELL COMPRISING A DEVICE FOR MONITORING AT LEAST ONE PARAMETER OF THE BATTERY CELL

(71) Applicant: ROBERT BOSCH GMBH, Stuttgart (DE)

(72) Inventor: Andreas Krauss, Tuebingen (DE)

(21) Appl. No.: 14/653,544

(22) PCT Filed: Nov. 25, 2013
(86) PCT No.: PCT/EP2013/074538

§ 371 Date: Jun. 18, 2015

(30) Foreign Application Priority Data
Dec. 18, 2012 (DE) 10 2012 223 480.2

(51) Int. Cl. H01M 10/48; H01M 10/42; H01M 2/02; H01M 10/04

(52) U.S. Cl. CPC H01M 10/48; H01M 10/0431; H01M 10/425; H01M 2/0237; H01M 2220/20; H01M 2010/4278

(57) ABSTRACT

The invention relates to a battery cell (1), in particular a lithium-ion cell, having at least one positive electrode (2), at least one negative electrode (3) and connections (4) which are connected in an electrically conductive manner to the electrodes (2, 3) for electrically contacting the battery cell (1). The battery cell (1) comprises a device (5) for monitoring at least one parameter of the battery cell (1) and the device (5) comprises at least one sensor (6, 7, 8, 9).

### BACKGROUND OF THE INVENTION

The invention relates to a battery cell, in particular a lithium-ion cell, having at least one positive electrode, at least one negative electrode and having connections which are electrically conductively connected to the electrodes for making electrical contact with the battery cell.

Batteries, such as rechargeable lithium-ion batteries, in particular, are of great significance as energy stores, in particular in order to provide the energy which is necessary for the drive in hybrid, plug-in hybrid or electric vehicles. Lithium-ion batteries, like other battery types, too, are usually constructed from one or more battery modules, wherein a plurality of battery cells are interconnected to form a battery module. Owing to the high energy densities of modern battery cells, in particular of lithium-ion cells, for instance LiFe—PO4 cells, deviations from the normal operation of such battery cells often lead to damage to the battery, wherein sometimes such battery cells are even at risk. Thus, it is possible in the event of high power consumption, for example during a charging process, or high power output for a battery cell to heat up, which, in addition to shortening of the service life of the battery cell in question, can lead to so-called thermal runaway of the battery cell. Owing to the chemical processes which are taking place, the battery cell heats up excessively in this case and flammable gases emerge, as a result of which there is an acute risk of fire and explosion. Furthermore, it is possible for contents which are harmful to health and to the environment to escape from the battery cell.

For these reasons, it is necessary to monitor the operation of battery cells in order to be able to recognize irregular operating states in good time. For this purpose, battery systems which comprise a plurality of mutually interconnected battery cells usually have a so-called battery management system, wherein sensors arranged on the battery cells monitor operating parameters of the battery cells, such as the temperature of the battery cells, for example, or, as a particularly relevant parameter, the battery cell voltage of a battery cell. What is particularly disadvantageous when monitoring parameters of individual battery cells is the high expenditure for the electrical connection of a sensor to a battery cell which is to be monitored, in particular since, in previously known battery systems with a battery management system, the sensors used for the monitoring each require a separate power supply and separate signal transmission paths.

In order to respond to this disadvantage, sometimes only the total voltage of a plurality of battery cells which are electrically connected in series is acquired by appropriate sensors. However, there is the disadvantage here that only the total voltage of said battery cells and the current flowing through said battery cells can be monitored. Since the battery cell voltages of the individual battery cells can vary greatly, however, it is often impossible to recognize an irregular operating state of an individual battery cell, as a result of which the monitoring of battery cells is less reliable.

### SUMMARY OF THE INVENTION

Against this background, an object of the present invention is, while avoiding the abovementioned disadvantages, to improve the monitoring of parameters of individual battery cells, in particular with respect to an improved connection of sensors to a battery cell, an improved or simplified power supply to sensors monitoring parameters of a battery cell, and an improved or simplified transmission of operating parameters of a battery cell acquired by sensors.

In order to achieve the object, what is proposed is a battery cell, in particular a lithium-ion cell, having at least one positive electrode, at least one negative electrode and having connections which are electrically conductively connected to the electrodes for making electrical contact with the battery cell, wherein the battery cell has a device for monitoring at least one parameter of the battery cell, and the device comprises at least one sensor. Advantageously, the device has at least one pressure sensor and/or a temperature sensor and/or a voltage sensor and/or a gas sensor and/or a fluid sensor. In particular, provision is made that the battery cell is an electric storage cell, that is to say that the battery cell is rechargeable.

According to a preferred configuration of the invention, the device is integrated at least partially in the battery cell. In particular, provision is made that the device is designed at least partially, preferably completely, as an MEMS component (MEMS: micro-electro-mechanical system) which is integrated in the battery cell. Advantageously, the device consists at least partially of a chemically resistant semiconductor material, such as silicon carbide (SiC). Advantageously, the device or the at least one sensor of the device, owing to the chemically resistant material, is not attacked by the chemical processes which occur in the battery cell or the contents of the battery cell, for instance an electrolyte, with the result that the functionality of the device and the at least one sensor is advantageously not impaired.

An advantageous embodiment of the invention provides that the battery cell is a wound battery cell, in particular a spiral-wound battery cell, with a cell winding and the device comprises at least one chemical sensor, wherein the at least one chemical sensor is integrated in the cell winding of the battery cell. The chemical sensor is advantageously designed to detect a gas and/or a fluid and to generate a detection signal. In particular, provision is made that the electrolyte of a battery cell makes contact with the at least one chemical sensor, for example by the at least one chemical sensor being integrated in the cell winding in a manner arranged on the separator band of a battery cell.

Another particularly preferred configuration of the invention provides that the electrodes of the battery cell make electrical contact with the device via at least one electrically conductive connection. In particular, provision is made that at least one sensor of the device is directly or indirectly connected via the device or a component of the device to the electrodes of the battery cell, wherein the at least one sensor is preferably arranged within the battery cell.

The device is advantageously designed to tap from the battery cell, via the at least one electrically conductive connection, an operating voltage required for the operation of the device. The battery cell to be monitored is thus advantageously utilizable as voltage source and thus utilizable for supplying power to the device or the components of the device, in particular for the at least one sensor of the device. What results from this, in particular, is the advantage that the sensors are supplied with the required energy by the battery cell itself during operation of the battery cell and no further external energy source is necessary and also no further supply line is necessary to supply electrical energy, as a result of which, in particular, the power supply of the sensors is improved. If the battery cell voltage in a battery cell falls so sharply that it is no longer possible for the battery cell to be monitored by means of the device, there is also no risk from such a battery cell. Moreover, what can be deduced from the lack of response from the sensors is that the battery cell is not functioning properly, in particular that the battery cell voltage has fallen below a particular battery cell voltage value. Such a fall in the battery cell voltage is in this case advantageously acquired as parameter by the device. According to an advantageous configuration of the invention, the device has at least one capacitor as energy store which maintains at least one limited functionality of the device, with the result that the device acquires as parameter, for example, the risk of an exhaustive discharge of the battery cell and can indicate such a risk, preferably to an external receiving unit.

According to another particularly advantageous configuration of the invention, the device comprises at least one voltage sensor, wherein the at least one voltage sensor is designed to acquire, via the at least one electrically conductive connection, a battery cell voltage present at the connections of the battery cell. Advantageously, the acquisition of the battery cell voltage of a single battery cell is thus made possible.

According to an advantageous development of the invention, the device and/or the at least one voltage sensor are/is designed to detect a predefined cell voltage being undershot. For this purpose, the device and/or the at least one voltage sensor may comprise, for example, a comparator element. Advantageously, the device or at least the at least one voltage sensor is designed such that the device or at least the at least one voltage sensor is transferred into an inactive state when the predefined battery cell voltage is undershot. Preferably, the device or at least the at least one voltage sensor is de-energized in the inactive state. Advantageously, the device or the at least one voltage sensor can be transferred into an inactive state, in which the device or the at least one voltage sensor requires no energy or at least less energy, via a voltage recognition, which advantageously recognizes a predefined battery cell voltage being undershot. Owing to such an inactive state of the device or the at least one voltage sensor, an exhaustive discharge of the battery cell to be monitored is advantageously avoided. Furthermore, in the event of a signal from the at least one voltage sensor not being present, in particular because said voltage sensor is in an inactive state, the device is advantageously designed to signal that a predefined battery cell voltage value has been undershot and thus a possible exhaustive discharge of the battery cell is impending. This signaling is particularly advantageous since an exhaustive discharge of a battery cell, in particular a lithium-ion cell, shortens the service life of a battery cell and reduces the performance of a battery cell. According to an advantageous configuration, a battery cell voltage detection is integrated in the at least one voltage sensor, which battery cell voltage detection switches the at least one voltage sensor or transfers said voltage sensor into an inactive state that requires less power, if the battery cell voltage acquired by the at least one voltage sensor falls below a predefined battery cell voltage and thus the battery cell voltage is recognized as being too low. Preferably, the entire device can also be transferred into an inactive state by this means.

Another advantageous configuration of the invention provides that the device is designed to acquire how often the predefined battery cell voltage is undershot. Advantageously, it is possible for the at least one voltage sensor and/or the device to permanently record a switch-off of the at least one voltage sensor, in particular owing to impending exhaustive discharge, wherein the device and/or the at least one voltage sensor comprise(s) at least one control unit and/or at least one storage element. In the event of the at least one voltage sensor being transferred into an inactive state, a count value is advantageously incremented in each case by the device and/or the at least one voltage sensor. If the battery is charged up again and the battery cell voltage falls below a predefined battery cell voltage once more, then another count value is incremented. As a result of this, the number of exhaustive discharges of the battery cell is advantageously acquired as parameter of the battery cell. In this way, damage to the battery cell by multiple exhaustive discharges can be recognized and signaled in good time.

According to another particularly preferred configuration of the invention, the device is designed to provide data for transmission to an external receiving unit. The external receiving unit may be, for example, an external control unit, in particular a battery management system. According to another advantageous configuration of the invention, the device is designed to transfer the provided data to an external receiving unit. In particular, provision is made for the device to be designed to transmit or to provide for transmission as data to an external receiving unit, measured values acquired by the at least one sensor. According to an advantageous configuration, provision is also made for further information stored in the at least one sensor and/or in at least one storage element of the device to be able to be transmitted, in addition to measured values of the at least one sensor, to an external receiving unit using the device, for example an identifier assigned in each case to the at least one sensor, which identifier enables the at least one sensor to be assigned to a defined battery cell. According to an advantageous configuration of the invention, data is transmitted wirelessly from the device to a receiving unit. In this connection, the device and/or the at least one sensor have/has at least one antenna. The data is either actively sent using the at least one antenna or is transmitted by means of an RFID data transmission (RFID: radio-frequency identification) by load modulation or as modulated backscattering. In the case of both variant configurations, the data is advantageously transmitted by means of suitable sending and modulating methods, which are known from RFID technology and make it possible, by means of appropriate channel selection, for a plurality of mutually interconnected battery cells to be able to be read in each case individually, too, or for received data of a specific battery cell to be able to be assigned appropriately. For this purpose, suitable anti-collision methods, for instance “listen before talk”, can be used.

According to a preferred variant configuration, provision is made that data is transmitted to an external receiving unit via the connections of the battery cell, wherein the device comprises a modulation unit for impressing a data signal on the connections of the battery cell. In the case of such a line-connected data transmission, the aforesaid sending and modulation methods can be used in conjunction with current modulation on the connections or the connection line of the battery cell. Advantageously, in the case of this variant configuration, no additional wiring is necessary in order to be able to transmit data to an external receiving unit. The modulation unit is advantageously designed to modulate or influence in a small way a flow of current proceeding from the battery cell, for example by a modulatable resistance. Such a resistance may be, for example, a transistor connected in series with the battery cell. According to a preferred variant configuration, the modulation unit comprises at least one coil, which enables an inductive signal coupling. To drive the coil, the modulation unit advantageously comprises a drive unit for the coil. In the case of a constructively simple variant configuration, a signal transmission takes place by a voltage pulse of a voltage tapped from the battery cell temporarily being applied to the coil, as a result of which a single pulse can be generated in the connection line. Information can thus be transmitted from the at least one sensor of the device to the unit via a defined temporal sequence of single pulses. A preferred configuration of the invention provides a controlled drive of the coil by means of a low-frequency and/or high-frequency amplifier. It is advantageously possible to realize a stable data transmission which is very insensitive to disturbance, even in the case of the extremely low current fluctuation achieved by inductive coupling, on the connections or the connection lines via a preferably digital modulation method (“digital spectrum modulation”) which operates redundantly for the data transmission on the connections of the battery cell or the connection lines of the battery cell with one or more carriers or via an encoded modulation. This is particularly advantageous since a very high level of disturbance is present owing to the often very irregular drawing of current from battery cells, for example by pulse-controlled inverters on the connection lines of the battery cells. In addition, the amount of data to be transmitted by the device is advantageously low. An interval with a temporal resolution of several seconds is advantageously sufficient in this case for the transmission of the data acquired for each battery cell by the at least one sensor of the device.

For improved assignment of received data to individual battery cells, the at least one sensor of a device of a battery cell is advantageously provided in each case with an individual identifier. This may also advantageously be used as serial number for the battery cell. Advantageously, further information relating to the manufacturer and/or the production date of the battery cell and/or further information relating to the battery cell can be stored in a storage unit of the device, wherein said data is provided by the device for transmission to an external receiving unit or transmitted by the device to an external receiving unit. According to an advantageous configuration, the data is transmitted between the device and the external receiving unit in an encrypted or at least partially encrypted manner. As a result, copies of battery cells can advantageously be recognized. If, for example, an overall cell voltage, which corresponds to a particular number of battery cells, is present at a battery pack comprising a plurality of battery cells, but the data transmitting from all of the battery cells is not recognized according to the encryption, either an exhaustive discharge of a battery cell is present or unsuitable battery cells are used in the battery pack.

According to a particularly advantageous variant configuration of the invention, the battery cell is a wound battery cell, in particular a spiral-wound battery cell, with a cell winding, wherein the modulation unit of the device comprises a coil which is formed by an electrical conductor applied to the cell winding. By way of example, the battery cell is a round wound cell. The electrical conductor is preferably a wire, which is preferably surrounded by an electrical insulator. The electrical conductor applied to the cell winding advantageously forms a coil by the turn of the winding.

According to another advantageous configuration of the invention, the battery cell is arranged in a pressure-tight cell housing, wherein the device has at least one pressure sensor arranged in the cell housing. In particular, provision is made that the cell housing comprises a cell cover with a safety valve, wherein the at least one pressure sensor is advantageously arranged below the safety valve. In a variant configuration in which the battery cell does not have a pressure-tight sleeve, for example in the case of a lithium-polymer battery cell, what is proposed is using a capacitively operating sensor instead of a pressure sensor. In the case of a polymer cell, such a sensor is advantageously installed inside the current collector foils, wherein the sensor is designed to recognize delamination, that is to say a release of layers of the battery cell, by inflation of the cell. Such a capacitive sensor uses at least one region of at least one current collector foil as electrode on a defined surface inside the battery cell. Said at least one electrode is advantageously electrically insulated from the rest of the battery cell and only connected to the capacitive sensor. In the event of the cell inflating, said electrode lifts away from the rest of the battery cell and the capacitance measurable between electrode and the rest of the battery cell becomes smaller. It is therefore possible for delamination to be recognized via the measurement of the capacitance, on the basis of acquired measured values, in particular in the event of a capacitance predefined as setpoint value being undershot.

### BRIEF DESCRIPTION OF THE DRAWINGS

Further advantageous details, features and configuration details of the invention are explained in more detail in connection with exemplary embodiments illustrated in the figures, in which:

FIG. 1 shows a block circuit diagram of an exemplary embodiment of a battery cell according to the invention;

FIG. 2 shows a schematic illustration of an exemplary embodiment of the arrangement of sensors of a device of a battery cell according to the invention; and

FIG. 3 shows a schematic illustration of an exemplary embodiment of a battery cell with no housing.

### DETAILED DESCRIPTION

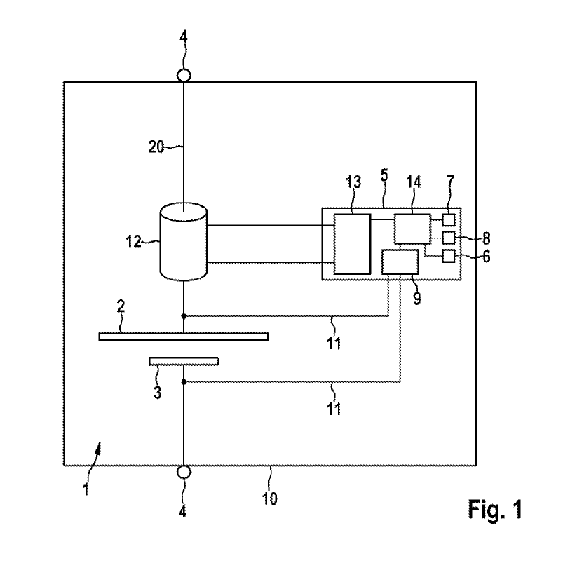

FIG. 1 illustrates a block circuit diagram of a battery cell 1 with a positive electrode 2 and a negative electrode 3. The battery cell 1 is surrounded by a pressure-tight battery cell housing 10. Connections 4 are electrically conductively connected to the electrodes 2 and 3 of the battery cell 1 in order to make electrical contact with the battery cell 1. The battery cell 1 has a device 5 for monitoring at least one parameter of the battery cell 1, wherein the device 5 comprises a plurality of sensors 6, 7, 8, 9. In the present case, the device 5 is completely arranged within the battery housing 10 and is thus completely integrated within the battery cell 1. In the present case, the battery cell 1 is a wound battery cell with a cell winding (not explicitly illustrated in FIG. 1). The device 5 is designed as a microsystem component which consists of a chemically resistant semiconductor material, for example of silicon carbide. The device 5 comprises a chemical sensor 6 which is designed to detect gas. The chemical sensor 6 may be integrated in the cell winding of the battery cell 1, for example. The pressure sensor 7 may be arranged, by way of example, below a safety valve (not explicitly illustrated in FIG. 1) of the battery cell housing 10, wherein a safety valve such as this is used, in the event of a buildup of gas in the battery cell, to be able to allow said gas to escape from the cell housing. The device 5 also comprises a temperature sensor 8 which is designed to acquire the battery cell temperature. The device 5 also comprises a voltage sensor 9.

The sensors 6, 7, 8, 9 are connected to a control unit 14 of the device 5. Said control unit 14 comprises a sensor interface for connecting to the sensors 6, 7, 8, 9, a data evaluation unit and a storage element for storing data. The electrodes 2 and 3 of the battery cell 1 make electrical contact with the device 5 via an electrically conductive connection 11. The device 5 can tap an operating voltage necessary for the operation of the device 5 or for the operation of the components of the device 5 from the electrodes 2, 3 of the battery cell 1 via said electrically conductive connection 11.

Furthermore, the voltage sensor 9 is designed to acquire the battery cell voltage present at the electrodes 2, 3 of the battery cell 1 via the electrically conductive connection 11. The voltage sensor 9 is also designed to detect a predefined battery cell voltage being undershot. In the event of said predefined battery cell voltage being undershot, the device 5 is transferred into an inactive state. As a variant configuration, provision is made that only the voltage sensor is transferred into an inactive state. In said inactive state, the device 5 and the voltage sensor 9 do not draw any power. Before the device 5 and the voltage sensor 9 are transferred into an inactive state, this is acquired by the control unit 14 of the device 5 and a count value is incremented in the storage element of the control unit 14, wherein the count value specifies the number of times the predefined battery cell voltage has been undershot. The device 5 is designed to transmit data to an external receiving unit, which is connected to the connections 4 of the battery cell 1 (not illustrated in FIG. 1). In order to transmit data, the device 5 has a modulation unit for impressing a data signal on the connections 4 of the battery cell 1. In this case, the modulation unit comprises a coil 12, wherein the coil 12 is formed by an electrical conductor applied to the cell winding of the battery cell 1. Said electrical conductor is electrically insulated with respect to the cell winding by an electrical insulator. The modulation unit also comprises a drive circuit 13 for driving the coil 12. The drive circuit 13 may be, for example, a low-frequency or a high-frequency amplifier. A signal on the connection line 20, which connects the positive electrode 2 to the connection 4 of the battery cell 1, is inductively coupled by means of the coil 12.

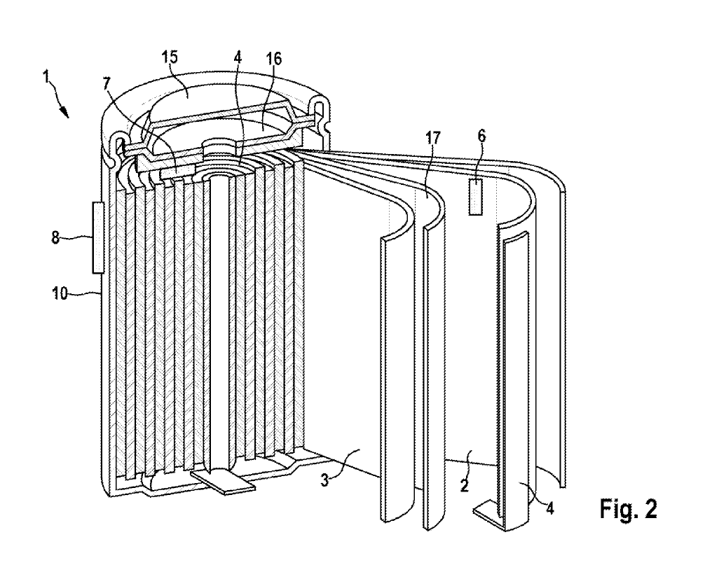

FIG. 2 shows preferred arrangement positions of sensors of a device of a battery cell according to the invention on the basis of an exemplary embodiment of a battery cell 1 which is designed as a round wound cell. The battery cell 1 shown in FIG. 2 has a wound negative electrode 2 and a wound positive electrode 3. The electrodes 2, 3 are electrically insulated from one another by a separator foil 17. Electrical contact is made with the battery cell 1 via the connections 4. The battery cell 1 has a cell housing 10, a cell cover 15 and a safety vent 16. In the illustrated exemplary embodiment, a pressure sensor 7 is arranged below the safety vent 16. In the present case, a chemical sensor for detecting the release of gas and/or liquid is arranged on the negative electrode 2. A temperature sensor 8 is arranged outside the battery cell 1 on the battery cell housing 10. A voltage sensor can likewise be arranged on the battery cell housing 10 or else within the battery cell 1, for example on the inner side of the battery cell housing 10. In this case, the negative electrode 2 and the positive electrode 3 make electrically conductive contact with a voltage sensor of this type. The device for monitoring at least one parameter of a battery cell according to the invention may likewise be arranged, for example, on the inner side of the battery cell housing 10 or on a layer of the cell winding, preferably on an outer layer of the cell winding.

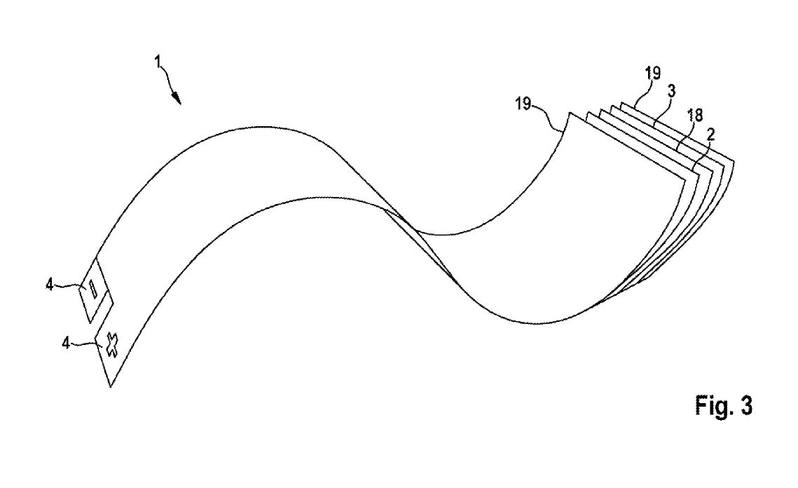

FIG. 3 shows an example of a battery cell 1 with no housing. As in the battery cell explained in connection with FIG. 1, this battery cell can also have a device for monitoring at least one parameter of the battery cell. The battery cell 1 illustrated in FIG. 3 has, in the present case, a negative electrode 2, a positive electrode 3, an electrolyte 18, which may be polymer-based, for example, and two current collector foils 19. Electrically conductive contact can be made with the battery cell 1 via the connections 4. According to an advantageous variant configuration which is not illustrated, a capacitively operating sensor is used inside the current collector foils 19, which sensor is designed to recognize delamination by inflation of the battery cell 1. Said capacitive sensor uses at least one region of at least one current collector foil 19 as electrode on a defined surface inside the battery cell 1. Said electrode is electrically insulated from the rest of the battery cell 1 and only connected to the capacitive sensor. In the event of the battery cell 1 inflating, said electrode lifts away from the rest of the battery cell 1 and the capacitance measured between said electrode and the rest of the battery cell 1 becomes smaller. In a battery cell which is designed in the manner of a battery cell illustrated in FIG. 3, a capacitively operating sensor of this type replaces a pressure sensor explained in connection with FIG. 1 and FIG. 2.

The exemplary embodiments illustrated in the figures and explained in connection therewith serve to explain the invention and do not limit the invention.

1. A battery cell (1) having at least one positive electrode (2), at least one negative electrode (3) and having connections (4) which are electrically conductively connected to the electrodes (2, 3) for making electrical contact with the battery cell (1), characterized in that the battery cell (1) has a device (5) for monitoring at least one parameter of the battery cell (1), wherein the device (5) comprises at least one sensor (6, 7, 8, 9).

2. The battery cell (1) as claimed in claim 1, characterized in that the device (5) is integrated at least partially in the battery cell (1).

3. The battery cell (1) as claimed in claim 2, characterized in that the battery cell (1) is a wound battery cell with a cell winding and the device (5) comprises at least one chemical sensor (6), wherein the at least one chemical sensor (6) is integrated in the cell winding of the battery cell (1).

4. The battery cell (1) as claimed in claim 1, characterized in that the electrodes (2, 3) of the battery cell (1) make electrical contact with the device (5) via at least one electrically conductive connection (11).

5. The battery cell (1) as claimed in claim 4, characterized in that the device (5) is configured to tap from the battery cell (1), via the at least one electrically conductive connection (11), an operating voltage required for the operation of the device (5).

6. The battery cell (1) as claimed in claim 4, characterized in that the device (5) comprises at least one voltage sensor (9), wherein the at least one voltage sensor (9) is configured to acquire, via the at least one electrically conductive connection (11), a battery cell voltage present at the connections (4) of the battery cell (1).

7. The battery cell (1) as claimed in claim 6, characterized in that at least one of the device (5) and the at least one voltage sensor (9) is configured to detect a predefined cell voltage being undershot.

8. The battery cell (1) as claimed in claim 7, characterized in that the device (5) or the at least one voltage sensor (9) is configured such that the device (5) or the at least one voltage sensor (9) is transferred into an inactive state when the predefined battery cell voltage is undershot.

9. The battery cell (1) as claimed in claim 7, characterized in that the device (5) is configured to acquire how often the predefined battery cell voltage is undershot.

10. The battery cell (1) as claimed in claim 1, characterized in that the device (5) is configured to provide data for transmission to an external receiving unit.

11. The battery cell (1) as claimed in claim 10, characterized in that data is transmitted to an external receiving unit via the connections (4) of the battery cell (1), wherein the device (5) comprises a modulation unit for impressing a data signal on the connections (4) of the battery cell (1).

12. The battery cell (1) as claimed in claim 11, characterized in that the battery cell (1) is a wound battery cell with a cell winding and the modulation unit comprises a coil (12), wherein the coil (12) is formed by an electrical conductor applied to the cell winding.

13. The battery cell (1) as claimed in claim 1, characterized in that the battery cell (1) is arranged in a pressure-tight cell housing (10) and the device (5) has at least one pressure sensor (7) arranged in the cell housing.

14. The battery cell (1) as claimed in claim 7, characterized in that the at least one voltage sensor (9) is configured to detect a predefined cell voltage being undershot.

15. The battery cell (1) as claimed in claim 13, characterized in that the device (5) is also configured to detect a predefined cell voltage being undershot.

16. The battery cell (1) as claimed in claim 7, characterized in that the device (5) is configured to detect a predefined cell voltage being undershot.
